(19) United States
(12) Patent Application Publication
(10) Pub. No.: US 2007/0105435 A1
(43) Pub. Date: May 10, 2007

(54) Connecting module

(75) Inventors: Chih-Tse Chen, Taoyuan Hsien (TW); Ching-Man Kao, Taoyuan Hsien (TW); Han-Cheng Hsu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/352,350

(22) Filed: Feb. 13, 2006

(30) Foreign Application Priority Data
Nov. 4, 2005 (TW) 94219042

(51) Int. Cl. H01R 13/60

(52) U.S. Cl. 439/540.1

(57) ABSTRACT

A connecting module includes a single housing including a front end, a first receiving hole and at least one second receiving hole. The first receiving hole is formed on the front end. The profile of the first receiving hole is used to receive a first external connecting plug. The second receiving hole is formed on the front end. The profile of the second receiving hole differs from that of the first receiving hole and is used to receive a second external connecting plug. The first and second receiving holes are arranged in a horizontal array.

### BACKGROUND OF THE INVENTION

1. Field of the Invention

The invention relates to a connecting module, and in particular relates to a connecting module providing two receiving holes with different profiles and arranged in a horizontal array.

2. Description of the Related Art

With the rapid progress in information technology and the popularity of electronic devices, various computing systems, such as computers and the Internet, and related peripheral devices have been correspondingly developed, to facilitate the speed of retrieving data acquired from other places in the world.

Connectors, such as a RJ-45 connector, and a Universal Serial Bus (USB) are conventionally considered as the requirements for a computer to connect to the Internet and electronic devices, in particular, USB provides a better solution to easily connect several different electronic devices at the same time. In other devices such as X-Box or PS2, modem, Asymmetric Digital Subscriber Line (ADSL), Very High Data Rate Digital Subscriber Line (VDSL), or other Digital Subscriber Line (DSL), connectors and USB are also essential requirements for data transmission.

In FIG. 1, a RJ-45 connector 10 and a USB 20 are two individual elements disposed on a circuit board 30. The RJ-45 connector 10 and the USB 20, however, are spaced from each other at an undesired distance and needed to be installed on the circuit board 30 by different processes. Thus, time and cost cannot be decreased and volume of the electronic device cannot be reduced.

### BRIEF SUMMARY OF THE INVENTION

A detailed description is given in the following embodiments with reference to the accompanying drawings.

The invention provides a connecting module for receiving a first external connecting plug and a second external connecting plug. The connecting module includes a first external connecting plug, a second external connecting plug, a single housing with a front end, and a first receiving hole and at least one second receiving hole, a first port disposed on the housing and exposed by the first receiving hole to connect to the first external connecting plug, and at least one second port disposed on the housing and exposed by the second receiving hole to connect to the second external connecting plug. The first and second receiving holes are formed on the front end. The profile of the first receiving hole is used to receive the first external connecting plug. The profile of the second receiving hole is different from that of the first receiving hole. The second receiving hole is used to receive the second external connecting plug. The first and second receiving holes are arranged in a horizontal array.

The first port is formed on the housing by embedding, engaging, bonding, welding, clicking, contacting, or integrally formed on the housing. The first external connecting plug can be a RJ-11, RJ-12 or RJ-45 connector. The second port is formed on the housing by embedding, engaging, bonding, welding, clicking, contacting, or integrally formed with the housing. The second external connecting plug can be a Universal Serial Bus (USB) plug with different structure or type.

In comparison with the related art, distance between the first and the second receiving holes of the invention can be narrowed, and the different receiving holes of the connecting module can be applied to a portable computer, X-Box or PS2, modem, Asymmetric Digital Subscriber Line (ADSL), Very High Data Rate Digital Subscriber Line (VDSL), or other Digital Subscriber Line (DSL) in a single step during the production process, to decrease required labor and time.

### BRIEF DESCRIPTION OF THE DRAWINGS

The invention can be more fully understood by reading the subsequent detailed description and examples with references made to the accompanying drawings, wherein:

FIG. 1 is a schematic view of a conventional connector (10) and a Universal Serial Bus (USB) connector (20);

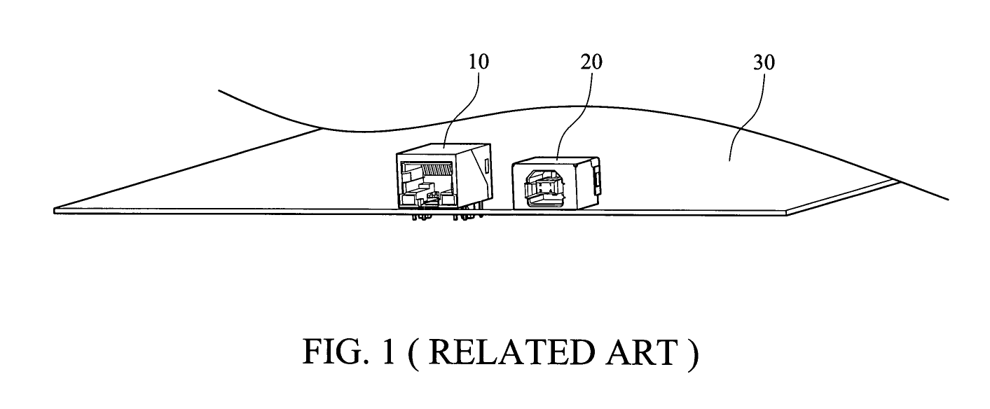

FIG. 2 is a schematic view of a connecting module (100A); and

FIG. 3 is a schematic view of a connecting module (100B).

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

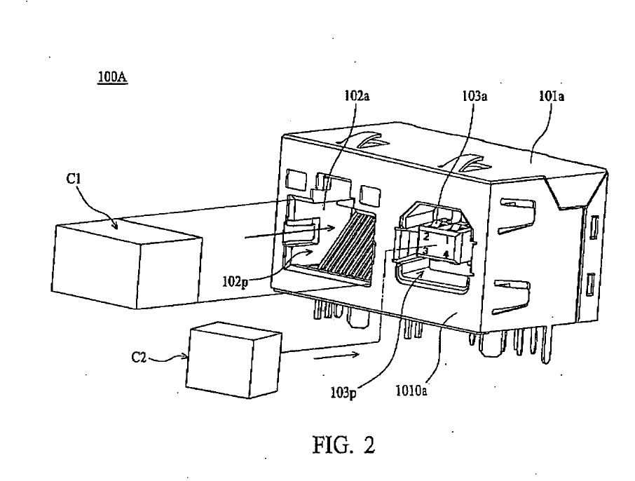

In FIG. 2, a connecting module 100A of the first embodiment includes a single housing 101a, a first port 102p is disposed on the housing 101a, and a second port 103p is disposed on the housing 101a. The housing 101a includes a front end 1010a, a first receiving hole 102a formed on the front end 1010a, and a second receiving hole 103a formed on the front end 1010a. The first port 102p is disposed on the housing 101a and is exposed to outside by the first receiving hole 102a, and the second port 103p is disposed on the housing 101a and is exposed to outside by the second receiving hole 103a. The profile of the first receiving hole 102a is used to receive a first external connecting plug C1 when the first external connecting plug C1 is connected to the first port 102p. The profile of the second receiving hole 103a is different from that of the first receiving hole 102a. The profile of the second receiving hole 103a is used to receive a second external connecting plug C2 when the second external connecting plug C2 is connected to the second port 103p.

The first port 102p is formed on the housing 101a by embedding, engaging, bonding, welding, clicking, contacting, or integrally formed on the housing 101a. In this embodiment, the first port 102p is a RJ port and the second port 103p is a Universal Serial Bus (USB) port, the first external connecting plug C1 can be a RJ-11, RJ-12 or RJ-45 connector, and the second external connecting plug C2 is a Universal Serial Bus (USB) plug. The second receiving hole 103a is formed on the housing 101a by embedding, engaging, bonding, welding, clicking, contacting, or integrally formed with the housing 101a. The material of the housing 101a is selected from plastic, metal, alloy, stainless or ceramic.

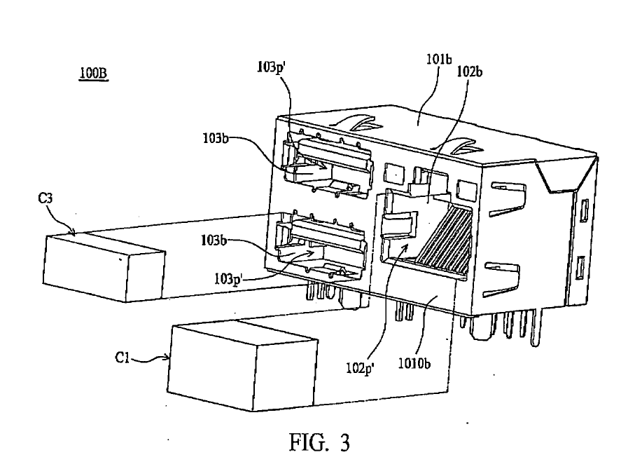

In FIG. 3, a connecting module 100B of the second embodiment is used for receiving a first external connecting plug C1 and a second external connecting plug C3. The connecting module 100B includes a housing 101b, a first port 102p1 disposed on the housing 101b, and two second ports 103p1 disposed on the housing 101b. The housing 101b includes a front end 1010b, a first receiving hole 102b formed on the front end 1010b for receiving the first external connecting plug C1, and two second receiving holes 103b formed on the front end 1010b for receiving the second external connecting plug C3.

The first port 102p1 is disposed on the housing 101b and is exposed to outside by the first receiving hole 102b, and the second ports 103p1 are disposed on the housing 101b and are exposed to outside by the second receiving holes 103b. The first receiving hole 102b of the connecting module 100B has the same structure as the first receiving hole 102a of the connecting module 100A of the first embodiment. In this embodiment, the first port 102p1 is a RJ port and the second ports 103p1 are Universal Serial Bus (USB) ports. The profile of the first receiving hole 102b is different from that of the second receiving hole 103b, and the first and second receiving holes 102b and 103b are arranged in a horizontal array. The adjacent second receiving holes 103b are arranged in a perpendicular array. The material of the housing 101b is selected from plastic, metal, alloy, stainless or ceramic.

In comparison with the related art, the distance between the first and the second receiving holes of the invention can be narrowed, and the different receiving holes of the connecting module can be applied to a portable computer, X-Box or PS2, modem, Asymmetric Digital Subscriber Line (ADSL), Very High Data Rate Digital Subscriber Line (VDSL), or other Digital Subscriber Line (DSL) in a single step during the production process, to decrease required labor and time. Particularly, the connecting module of the invention is suitable for small-size and thin electronic devices, as it can help to decrease volume and weight of the electronic device.

While the invention has been described by way of example and in terms of the preferred embodiments, it is to be understood hat the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A connecting module for connecting a first external connecting plug and a second external connecting plug, comprising:
a single housing comprising a front end,
a first receiving hole formed on the front end and having a profile corresponding to the first external connecting plug, and
at least one second receiving hole formed on the front end to receive the second external connecting plug;
a first port integrally formed with the single housing and exposed by the first receiving hole to connect to the first external connecting plug; and
at least one second port integrally formed with the single housing and exposed by the at least one second receiving hole to connect to the second external connecting plug, wherein a profile of the at least one second receiving hole differs from that of the first receiving hole, and the first receiving hole and the at least one second receiving hole are arranged in a horizontal array.

2. The connecting module as claimed in claim 1, wherein the first port is formed on the single housing by embedding, engaging, bonding, welding, clicking, or contacting.

3. (canceled)

4. The connecting module as claimed in claim 1, wherein the at least one second port is formed on the single housing by embedding, engaging, bonding, welding, clicking, or contacting.

5. (canceled)

6. The connecting module as claimed in claim 1, wherein the amount of the at least one second receiving hole is two, and the second receiving holes are adjacent to each other and arranged in a perpendicular array.

7. The connecting module as claimed in claim 1, wherein the material of the single housing is selected from plastic, metal, alloy, stainless or ceramic.

8. The connecting module as claimed in claim 1, wherein the connecting module is applied to a portable computer, X-Box or PS2, a modem, Asymmetric Digital Subscriber Line, Very High Data Rate Digital Subscriber Line, or other Digital Subscriber Lines.

9. A connecting module for connecting an RJ plug and a Universal Serial Bus plug, comprising:
a single housing comprising a front end,
a first receiving hole formed on the front end to receive the RJ plug, and
at least one second receiving hole formed on the front end to receive the Universal Serial Bus plug;
a first port integrally formed with the single housing and exposed by the first receiving hole to connect to the RJ plug; and
at least one second port integrally formed with the single housing and exposed by the at least one second receiving hole to connect to the Universal Serial Bus plug, wherein the first receiving hole and the at least one second receiving hole are arranged in a horizontal array.

10. The connecting module as claimed in claim 9, wherein the first port is formed on the single housing by embedding, engaging, bonding, welding, clicking, or contacting.

11. (canceled)

12. The connecting module as claimed in claim 9, wherein the at least one second port is formed on the housing by embedding, engaging, bonding, welding, clicking, or contacting.

13. The connecting module as claimed in claim 9, wherein the amount of the at least one second receiving hole is two, and the second receiving holes are adjacent to each other and arranged in a perpendicular array.

14. The connecting module as claimed in claim 9, wherein the material of the single housing is selected from plastic, metal, alloy, stainless or ceramic.

15. The connecting module as claimed in claim 9, wherein the connecting module is applied to a portable computer, X-Box or PS2, modem, Asymmetric Digital Subscriber Line, Very High Data Rate Digital Subscriber Line, or other Digital Subscriber Lines.

16. A connecting module for connecting a first external connecting plug and a second external connecting plug, comprising:
a single housing comprising a first receiving hole having a profile corresponding to the first external connecting plug and at least one second receiving hole to receive the second external connecting plug;
a first port disposed on the single housing and exposed by the first receiving hole to connect to the first external connecting plug; and
at least one second port disposed on the single housing and exposed by the at least one second receiving hole to connect to the second external connecting plug, wherein a profile of the first receiving hole is different from that of the at least one second receiving hole, and the first receiving hole and the at least one second receiving hole are arranged in a horizontal array.

17. The connecting module as claimed in claim 16, wherein the first port is an RJ port.

18. The connecting module as claimed in claim 16, wherein the at least one second port is a Universal Serial Bus (USB) port.

19. The connecting module as claimed in claim 16, wherein the amount of the at least one second receiving hole is two, and the at least one second receiving holes are adjacent to each other and arranged in a perpendicular array.

20. The connecting module as claimed in claim 16, wherein the first port is formed on the single housing by embedding, engaging, bonding, welding, clicking, contacting, or integrally formed with the single housing.

21. The connecting module as claimed in claim 16, wherein the at least one second port is formed on the single housing by embedding, engaging, bonding, welding, clicking, contacting, or integrally formed with the single housing.

22. The connecting module as claimed in claim 16, wherein the material of the single housing is selected from plastic, metal, alloy, stainless or ceramic.

23. The connecting module as claimed in claim 16, wherein the connecting module is applied to a portable computer, X-Box or PS2, modem, Asymmetric Digital Subscriber Line, Very High Data Rate Digital Subscriber Line, or other Digital Subscriber Lines.
